(19) United States
(12) Patent Application Publication
(10) Pub. No.: US 2025/0065249 A1
(43) Pub. Date: Feb. 27, 2025

(54) GAS-LIQUID SEPARATOR

(71) Applicant: Honda Motor Co., Ltd., Tokyo (JP)

(72) Inventors: Shota Maeda, Saitama (JP); Yuji Okamura, Saitama (JP); Tsutomu Kubo, Saitama (JP)

(21) Appl. No.: 18/800,054

(22) Filed: Aug. 10, 2024

(30) Foreign Application Priority Data
Aug. 25, 2023 (JP) 2023-136700

(51) Int. Cl. B01D 19/00

(52) U.S. Cl. CPC B01D 19/0042

(57) ABSTRACT

A gas-liquid separator including a container including an upper part, a bottom part and a side part connecting the upper part and the bottom part to form a gas-liquid separation chamber where a gas-liquid two-phase flow is separated into a gas phase and a liquid phase. The side part includes a first and second side parts opposed to each other, the container includes an inlet provided at the upper part so that the gas-liquid two-phase flow flows into and an outlet provided at the first side part so that the gas phase separated in the gas-liquid separation chamber flows out, and the gas-liquid separator further includes a flow path forming part forming an inclined flow path extending diagonally downward so that the gas-liquid two-phase flow flowed into through the inlet collides with the second side part below the outlet.

### CROSS-REFERENCE TO RELATED APPLICATION

This application is based upon and claims the benefit of priority from Japanese Patent Application No. 2023-136700 filed on Aug. 25, 2023, the content of which is incorporated herein by reference.

### BACKGROUND OF THE INVENTION

### Field of the Invention

This invention relates to a gas-liquid separator.

### Description of the Related Art

Conventionally, there has been known a gas-liquid separator which includes a container with an inlet for gas-liquid mixture provided at the top, a liquid reservoir part provided at the bottom, and a gas outlet provided on the side wall, and in the container, a baffle plate that shields the gas outlet from the inlet for the gas-liquid mixture. Such a gas-liquid separator is described, for example, in Japanese Unexamined Patent Publication No. 2001-29718 (JP2001-029718A). In the gas-liquid separator described in JP2001-029718A, the baffle plate has a sloped portion so that the area of the opening at the bottom of the baffle plate is increased.

However, as described in JP2001-029718A, merely increasing the area of the opening at the bottom of the baffle plate to reduce the flow speed of the gas makes it difficult to sufficiently enhance the gas-liquid separation performance.

### SUMMARY OF THE INVENTION

An aspect of the present invention is a gas-liquid separator including a container including an upper part, a bottom part and a side part connecting the upper part and the bottom part to form a gas-liquid separation chamber where a gas-liquid two-phase flow is separated into a gas phase and a liquid phase. The side part includes a first side part and a second side part opposed to each other, the container includes an inlet provided at the upper part so that the gas-liquid two-phase flow flows into the gas-liquid separation chamber through the inlet, and an outlet provided at the first side part so that the gas phase separated in the gas-liquid separation chamber flows out of the gas-liquid separation chamber through the outlet, and the gas-liquid separator further includes a flow path forming part forming an inclined flow path extending diagonally downward so that the gas-liquid two-phase flow flowed into through the inlet collides with the second side part below the outlet.

### BRIEF DESCRIPTION OF THE DRAWINGS

The objects, features, and advantages of the present invention will become clearer from the following description of embodiments in relation to the attached drawings, in which:

FIG. 1 is a perspective view schematically showing an overall configuration of a fuel cell stack to which a gas-liquid separator according to an embodiment of the present invention is attached;

FIG. 2 is a diagram showing schematically main components of a fuel cell system to which the gas-liquid separator according to the embodiment of the present invention is applied;

FIG. 3 is a perspective view of the gas-liquid separator according to the embodiment of the present invention;

FIG. 4 is a rear view of the gas-liquid separator of FIG. 3;

FIG. 5 is a cross-sectional view along line V-V of FIG. 4;

FIG. 6 is a perspective view of a lower container included in the gas-liquid separator of FIG. 3, diagonally viewed from above;

FIG. 7 is a plan view of the lower container included in the gas-liquid separator of FIG. 3;

FIG. 8 is a perspective view of a flow path forming member included in the gas-liquid separator of FIG. 3;

FIG. 9A is a diagram showing an example of a flow of fuel exhaust gas in the gas-liquid separator according to the embodiment of the present invention;

FIG. 9B is a diagram showing another example of a flow of fuel exhaust gas in the gas-liquid separator according to the embodiment of the present invention; and

FIG. 10 is a diagram showing a modification of FIG. 5.

### DETAILED DESCRIPTION OF THE INVENTION

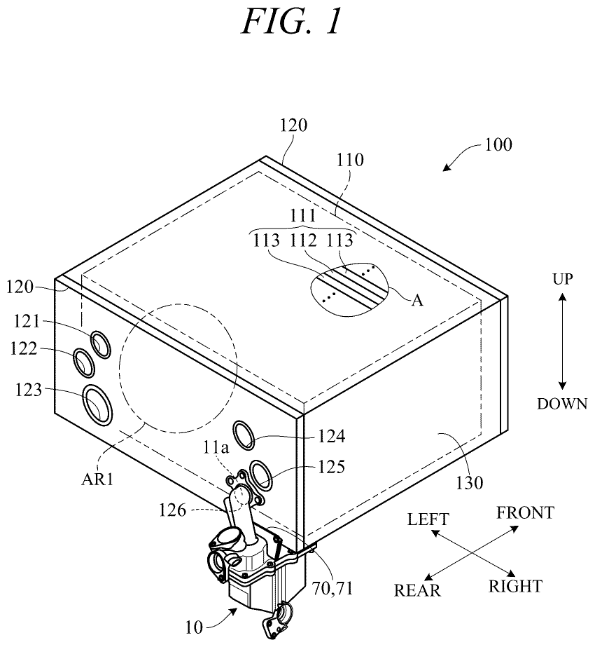

Hereinafter, embodiments of the present invention will be described with reference to FIGS. 1 to 10. A gas-liquid separator according to an embodiment of the present invention is applied to a fuel cell system having a fuel cell. The fuel cell system is, for example, mounted on a vehicle and generates electric power for driving the vehicle. The fuel cell system includes a fuel cell stack configured by stacking a plurality of power generation cells. The gas-liquid separator according to the embodiment is attached to such a fuel cell stack.

FIG. 1 is a perspective view schematically showing an overall configuration of a fuel cell stack 100 to which a gas-liquid separator 10 according to the embodiment is attached. For convenience, the three axes orthogonal to each other as shown in FIG. 1 will be defined as a front-rear direction, a left-right direction, and an up-down direction, and the configuration of each part will be explained according to this definition. The downward direction in the up-down direction corresponds to the direction of gravity. The front-rear direction and the left-right direction, for example, correspond to the front-rear direction and the left-right direction of a vehicle. However, the front-rear direction and the left-right direction do not necessarily have to correspond to the front-rear direction and the left-right direction of the vehicle.

As shown in FIG. 1, the fuel cell stack 100 includes a cell stacked body 110, end plates 120 and 120 arranged at both front and rear ends of the cell stacked body 110, and a case 130 that surrounds the cell stacked body 110. The fuel cell stack 100 has a substantially rectangular parallelepiped shape as a whole. A part of the case 130 is shown by being broken away in part “A” of FIG. 1. As shown in part “A” of FIG. 1, the cell stacked body 110 is configured by a plurality of power generation cells 111 (for convenience, only a single power generation cell 111 is shown) stacked in the front-rear direction.

The power generation cell 111 includes a unitized electrode assembly (UEA) 112 having a membrane electrode assembly including an electrolyte membrane and an electrode, and separators 113 and 113 that are disposed on both front and rear sides of the unitized electrode assembly 112 and sandwich the unitized electrode assembly 112. The unitized electrode assembly 112 and the separators 113 are alternately disposed in the front-rear direction. The separator 113 includes a pair of front and rear metal thin plates having a corrugated cross section, and is integrally formed by joining outer peripheral edges of the thin plates. A cooling flow path through which a cooling medium (for example, water) flows is formed between the pair of thin plates, and a power generation surface of the power generation cell 111 is cooled by the flow of the cooling medium.

The front separator 113 of the unitized electrode assembly 112 is, for example, a separator on an anode side (anode separator), and an anode flow path through which a fuel gas including hydrogen flows is formed between the anode separator 113 and the unitized electrode assembly 112. The rear separator 113 of the unitized electrode assembly 112 is, for example, a separator on a cathode side (cathode separator), and a cathode flow path through which an oxidant gas including oxygen flows is formed between the cathode separator 113 and the unitized electrode assembly 112.

The unitized electrode assembly 112 includes a membrane electrode assembly and a resin frame that supports a peripheral portion of the membrane electrode assembly. The membrane electrode assembly has an electrolyte membrane, an anode electrode provided on a front surface of the electrolyte membrane, and a cathode electrode provided on a rear surface of the electrolyte membrane. The electrolyte membrane is, for example, a solid polymer electrolyte membrane. The anode electrode is an electrode catalyst layer formed on a front surface of the electrolyte membrane and served as a reaction field of electrode reaction. A gas diffusion layer is formed on a front surface of the electrode catalyst layer to spread and supply the fuel gas. The cathode electrode is an electrode catalyst layer formed on a rear surface of the electrolyte membrane and served as a reaction field of electrode reaction. A gas diffusion layer is formed on a rear surface of the electrode catalyst layer to spread and supply the oxidant gas.

In the anode electrode, the fuel gas (hydrogen) supplied through the anode flow path and the gas diffusion layer is ionized by an action of a catalyst, passes through the electrolyte membrane, and moves to the cathode electrode side. Electrons generated at this time pass through an external circuit and are extracted as electric energy. In the cathode electrode, an oxidant gas (oxygen) supplied via the cathode flow path and the gas diffusion layer reacts with hydrogen ions guided from the anode electrode and electrons moved from the anode electrode to generate water. The generated water gives an appropriate humidity to the electrolyte membrane, and excess water is discharged to an outside of the unitized electrode assembly 112.

In the front end plate 120, through-holes 121 to 126, which penetrate the end plate 120 in the front-rear direction, are opened. The through-holes 121 to 123 are offset from each other in the up-down direction at the left end of the end plate 120, and the through-holes 124 to 126 are offset from each other in the up-down direction at the right end of the end plate 120. In FIG. 1, the lowermost through-hole 126 on the right side is shown covered by the flange portion 11a of the gas-liquid separator 10.

Inside the cell stacked body 110, fuel gas is supplied through the through-hole 121, oxidant gas is supplied through the through-hole 124, and cooling medium is supplied through the through-hole 125. From the cell stacked body 110, the cooling medium is discharged outside the fuel cell stack 100 through the through-hole 122, the oxidant exhaust gas through the through-hole 123, and the fuel exhaust gas through the through-hole 126, respectively. The oxidant exhaust gas is oxidant gas that has been partially used in the cathode electrode and is a gas-liquid two-phase flow containing moisture. The fuel exhaust gas is fuel gas that has been partially used in the anode electrode and is a gas-liquid two-phase flow containing moisture.

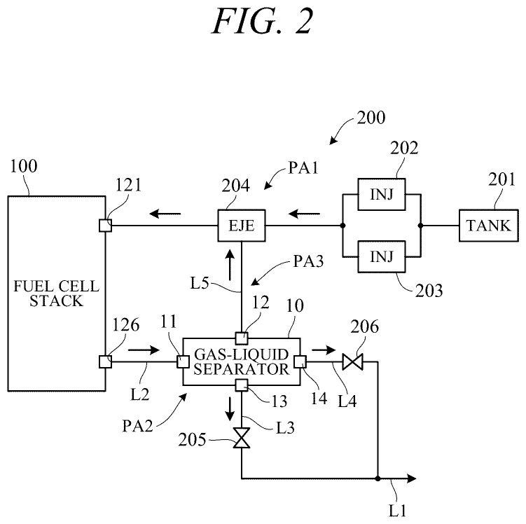

FIG. 2 is a diagram showing schematically main components of the fuel cell system 200, especially a flow of the fuel gas. As shown in FIG. 2, the fuel cell system 200 has a supply path PA1 that leads the fuel gas to the fuel cell stack 100 through the through-hole 121, a discharge path PA2 that leads the fuel exhaust gas from the fuel cell stack 100 to the drainage line L1 through the through-hole 126, and a circulation path PA3 that leads (recirculates) the fuel gas separated from the fuel exhaust gas back to the supply path PA1.

The supply path PA1 includes a tank 201 where high-pressure fuel gas is stored, a pair of injectors 202 and 203 that inject the fuel gas supplied from the tank 201, and an ejector 204 interposed between the injectors 202 and 203 and the through-hole 121 of the fuel cell stack 100. The discharge path PA2 includes the gas-liquid separator 10 connected to the through-hole 126 of the fuel cell stack 100 via a pipeline L2, a drain valve 205 connected to the gas-liquid separator 10 via a pipeline L3, and a purge valve 206 connected to the gas-liquid separator 10 via a pipeline L4. The circulation path PA3 includes a pipeline L5 that connects the gas-liquid separator 10 and the ejector 204. The operation of the injectors 202 and 203 and opening and closing actions of the drain valve 205 and the purge valve 206 are controlled by a controller not shown.

Although detailed illustration is omitted, the ejector 204 has a nozzle section, a suction section, a merging section, and a diffuser section. The fuel gas injected from the injectors 202 and 203 passes through the small-diameter nozzle section and then flows into the diffuser section via the merging section. At this time, the fuel gas is drawn into the ejector 204 from the pipeline L5 through the suction section. The drawn fuel gas merges with the fuel gas that has passed through the nozzle section at the merging section, and after being made into a uniform flow in the diffuser section, it is supplied to the fuel cell stack 100 through the through-hole 121.

The gas-liquid separator 10 includes an inlet 11 through which the fuel exhaust gas flows in, an outlet 12 through which the fuel gas separated in the gas-liquid separator 10 flows out, a drainage port 13 through which the water separated in the gas-liquid separator 10 is discharged, and an exhaust port 14 through which the fuel exhaust gas is discharged. As shown in FIG. 1, the gas-liquid separator 10 is positioned behind the right end of the fuel cell stack 100, protruding below the bottom surface of the fuel cell stack 100. Furthermore, in a rear area ARI of the fuel cell stack 100 on the left side of the gas-liquid separator 10, an unillustrated fuel injection unit with the injectors 202 and 203 and the ejector 204 integrated is disposed.

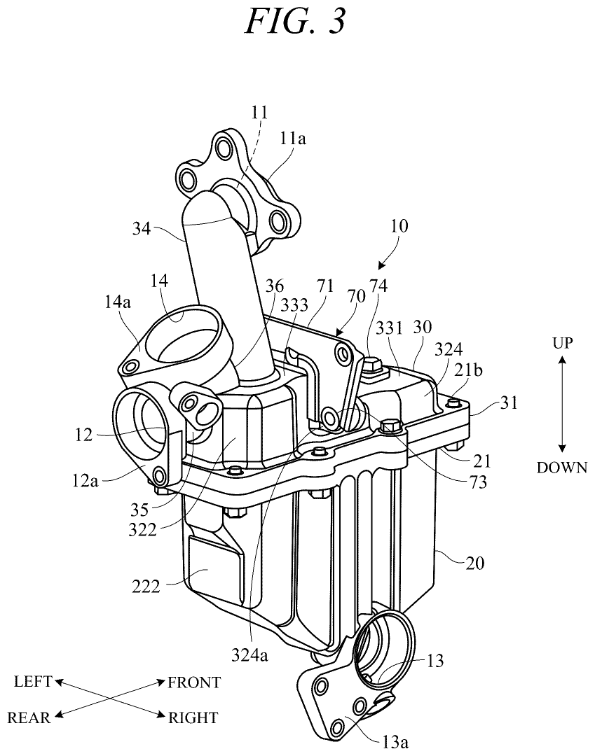

FIG. 3 is a perspective view of the gas-liquid separator 10 alone. As shown in FIG. 3, the inlet 11 is provided at the top of the gas-liquid separator 10, and the drainage port 13 is provided at the bottom. The outlet 12 and the exhaust port 14 are provided in the middle height of the gas-liquid separator 10.

A flange portion 11a is provided around the inlet 11. The front end surface of the flange portion 11a is a mounting surface, and the flange portion 11a is attached to the rear end surface (FIG. 1) of the fuel cell stack 100 via the mounting surface with bolts. A flange portion 12a is provided around the outlet 12. The rear end surface of the flange portion 12a is a mounting surface, and the end of a circulation pipe connected to the ejector 204 is attached to the flange portion 12a via the mounting surface. A flange portion 13a is provided around the drainage port 13. The right end surface of the flange portion 13a is a mounting surface, and the drain valve 205 is attached to the flange portion 13a via the mounting surface. A flange portion 14a is provided around the exhaust port 14. The upper end surface of the flange portion 14a is a mounting surface, and the purge valve 206 is attached to the flange portion 14a via the mounting surface.

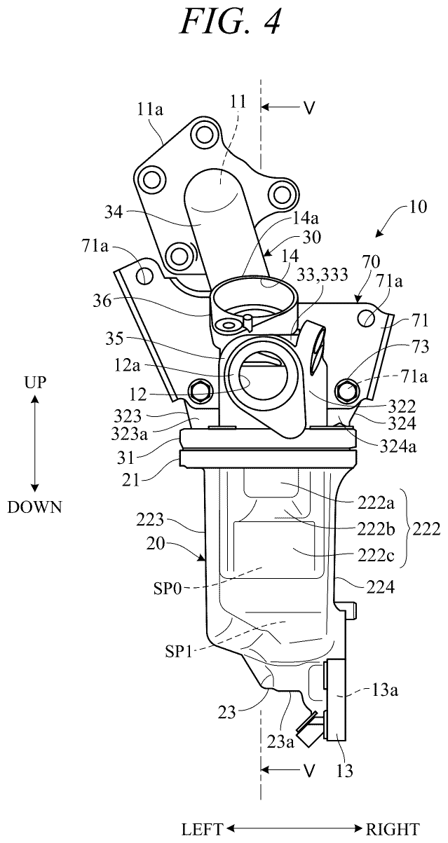

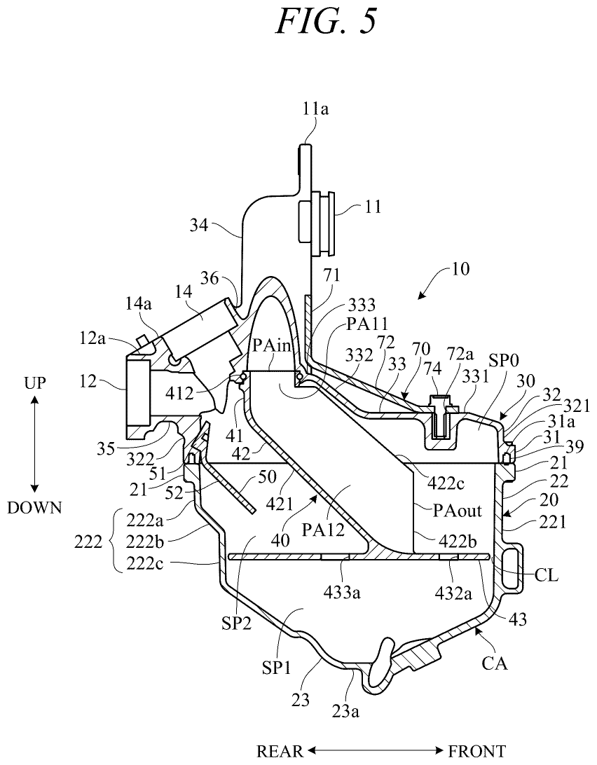

FIG. 4 is a rear view of the gas-liquid separator 10 (viewed from the rear), and FIG. 5 is a cross-sectional view of a main part of the gas-liquid separator 10 cut along the line V-V in FIG. 4. As shown in FIGS. 4 and 5, the gas-liquid separator 10 has a lower container 20, which is open at the top and substantially concave towards the bottom, and an upper container 30, which is open at the bottom and substantially concave towards the top. The lengths of the lower container 20 and the upper container 30 in the front-rear direction are longer than the lengths in the left-right direction, and the gas-liquid separator 10 is formed elongated in the front-rear direction. The lower container 20 and the upper container 30 are formed by resin molding with resin as the constituent material.

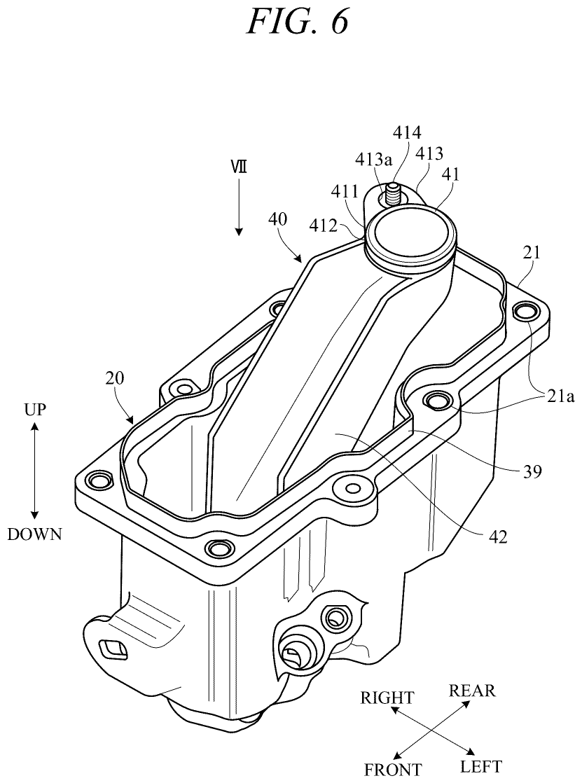

FIG. 6 is a perspective view of the lower container 20 diagonally viewed from above. FIG. 6 also shows a flow path forming member 40 housed inside the lower container 20. As shown in FIG. 6, a substantially rectangular frame-shaped flange portion 21 is provided at the upper end of the lower container 20. Multiple screw holes 21a are provided at the flange portion 21 over the entire circumference of the flange portion 21. As shown in FIG. 3, a substantially rectangular frame-shaped flange portion 31 is provided at the lower end of the upper container 30, corresponding to the flange portion 21. Multiple through-holes are provided at the flange portion 31, corresponding to the positions of the screw holes 21a. Bolts 21b inserted through the through-holes of the flange portion 31 are screwed into the screw holes 21a, thereby integrally fastening the upper container 30 and the lower container 20.

As shown in FIG. 5, a concave portion 31a is provided along the entire circumference of the lower end surface of the flange portion 31 of the upper container 30, and a sealing member 39 is arranged along the concave portion 31a. The lower end surface of the sealing member 39 contacts the upper end surface of the flange portion 21. Both the upper end surface of the lower container 20 and the lower end surface of the upper container 30 extend in a substantially horizontal direction. By fastening the lower container 20 and the upper container 30 through the sealing member 39, an internal space SP0, which is isolated from the outside, is formed inside the lower container 20 and the upper container 30. A container CA that forms the internal space SP0 is configured by the lower container 20 and the upper container 30.

As shown in FIGS. 4 and 5, the lower container 20 has side walls 22 extending in the vertical direction, namely, a front wall 221, a rear wall 222, a left wall 223, and a right wall 224, and a bottom wall 23. The rear wall 222 has an upper rear wall 222a extending downward from the flange portion 21, a sloping rear wall 222b extending forward with a downward slope from the lower end of the upper rear wall 222a, and a lower rear wall 222c extending downward from the lower end of the sloping rear wall 222b.

The bottom wall 23 slopes downward from the lower end of the front wall 221 and the lower end of the rear wall 222 (lower rear wall 222c) towards the central portion in the front-rear direction. At the bottom of the internal space SP0, a storage chamber SP1 where water separated from the fuel exhaust gas is stored, is formed. The central portion of the bottom wall 23 in the front-rear direction is the lowermost portion 23a of the lower container 20. On the right side of the lowermost portion 23a, a flange portion 13a with a drainage port 13 is provided. The storage chamber SP1 communicates with the external space of the gas-liquid separator 10 through the drainage port 13.

The upper container 30 has side walls 32 extending in the vertical direction, namely, a front wall 321, a rear wall 322, a left wall 323, and a right wall 324, and an upper wall 33. As shown in FIGS. 3 and 4, the right wall 324 has a right rear face portion 324a extending in the left-right direction at the central portion in the front-rear direction. Similarly, the left wall 323 has a left rear face portion 323a extending in the left-right direction at the central portion in the front-rear direction.

More specifically, the right wall 324 extends rearward from the right end of the front wall 321, then bends approximately at a right angle to the left at the central portion in the front-rear direction and extends for a predetermined length to form the right rear face portion 324a. Furthermore, the right wall 324 extends rearward from the left end of the right rear face portion 324a. The left wall 323 extends rearward from the left end of the front wall 321, then bends approximately at a right angle to the right at the central portion in the front-rear direction and extends for a predetermined length to form the left rear face portion 323a. Furthermore, the left wall 323 extends rearward from the right end of the left rear face portion 323a. Therefore, the length in the left-right direction of the upper wall 33 in front of the left rear face portion 323a and the right rear face portion 324a is longer than the length in the left-right direction of the upper wall 33 behind the left rear face portion 323a and the right rear face portion 324a.

As shown in FIG. 5, the upper wall 33 includes a front upper wall 331 that extends rearward substantially horizontally from the upper end of the front wall 321 to the left rear face portion 323a and the right rear face portion 324a, an inclined upper wall 332 that extends inclined rearward and upward from the rear end of the front upper wall 331, and a rear upper wall 333 that extends substantially horizontally from the rear end of the inclined upper wall 332 to the upper end of the rear wall 322. Therefore, the height of the left wall 323 and the right wall 324 gradually increases from the middle portion in the front-rear direction towards the rear, and the upper end of the rear wall 322 is positioned higher than the upper end of the front wall 321.

As shown in FIGS. 4 and 5, a substantially circular opening is provided in the rear upper wall 333, and a substantially cylindrical pipe part 34 is connected to the rear upper wall 333 to cover this opening. The pipe part 34 extends upward from the rear upper wall 333. As shown in FIG. 3, the front end face of the pipe part 34 is positioned slightly behind the left rear face portion 323a of the left wall 323 and the right rear face portion 324a of the right wall 324. The upper end of the pipe part 34 is bent forward, and an inlet 11 is provided at the tip (front end) of the pipe part 34, and a flange portion 11a is provided around the inlet 11. As shown in FIG. 5, the flange portion 11a is positioned above the central portion in the front-rear direction of the upper wall 33. The internal space SP0 of the container CA communicates with the external space of the gas-liquid separator 10 through the pipe part 34 and the inlet 11.

A substantially circular opening is provided in the rear wall 322, and a substantially cylindrical pipe part 35 is connected to the rear wall 322 to cover this opening. The pipe part 35 projects rearward from the rear wall 322. An outlet 12 is provided at the tip (rear end) of the pipe part 35, and a flange portion 12a is provided around the outlet 12. The internal space SP0 of the container CA communicates with the external space of the gas-liquid separator 10 through the pipe part 35 and the outlet 12.

At the corner where the rear end of the upper wall 33 (rear upper wall 333) intersects with the upper end of the rear wall 322, a substantially circular opening is provided, and a substantially cylindrical pipe part 36 is connected to the corner to cover this opening. The pipe part 36 projects diagonally rearward and upward between the pipe part 34 and the pipe part 35. An exhaust port 14 is provided at the tip of the pipe part 36, and a flange portion 14a is provided around the exhaust port 14. The internal space SP0 of the container CA communicates with the external space of the gas-liquid separator 10 through the pipe part 36 and the exhaust port 14.

As shown in FIGS. 3 to 5, the gas-liquid separator 10 is attached to the fuel cell stack 100 via a bracket 70. The bracket 70 has a substantially U-shaped base portion 71 that extends in the left-right direction across the upper wall 33 of the upper container 30 in front of the pipe part 34, and an inclined portion 72 that extends diagonally forward and downward from the lower end of the central portion in the left-right direction (bottom of the U) of the base portion 71, and is formed by bending a plate member. As shown in FIG. 4, through-holes 71a are provided in the lower right end, upper right end, lower left end, and upper left end of the base portion 71, respectively. In the through-holes 71a of the lower right and lower left ends, bolts 73 are inserted from the rear.

As shown in FIGS. 3 and 4, the left and right ends of the front face of the base portion 71 come into contact with the left rear face portion 323a of the left wall 323 and the right rear face portion 324a of the right wall 324, respectively. In the left rear face portion 323a and the right rear face portion 324a, screw holes are provided corresponding to the positions of the through-holes 71a, and the bolts 73 inserted through the through-holes 71a are screwed into the screw holes. As shown in FIG. 5, a through-hole 72a is provided at the front end of the inclined portion 72. A bolt 74 is inserted into the through-hole 72a from above, and the bolt 74 is screwed into a bottomed screw hole provided in the upper wall 33 (front upper wall 331). Thus, the bracket 70 is fixed at three points to the left wall 323, the right wall 324, and the upper wall 33 by the bolts 73 and 74.

As shown in FIG. 1, the front surface of the upper portion of the base portion 71 of the bracket 70 comes into contact with the rear end surface of the fuel cell stack 100 (end plate 120). On the rear surface of the fuel cell stack 100, screw holes are provided at the contact position of the bracket 70. In the through-holes 71a (FIG. 4) of the upper left end portion and the upper right end portion of the base portion 71, bolts are inserted from the rear, and the bolts are screwed into the screw holes on the rear surface of the fuel cell stack 100.

Thus, the bracket 70 is fixed to the fuel cell stack 100, and the gas-liquid separator 10 is attached to the fuel cell stack 100 through the bracket 70. At this time, the part (part of the upper container 30 and the lower container 20) in front of the pipe part 34 of the gas-liquid separator 10 is disposed below the fuel cell stack 100. Therefore, the protrusion of the gas-liquid separator 10 to the rear of the fuel cell stack 100 can be minimized, allowing for an efficient arrangement of the gas-liquid separator 10. Furthermore, the gas-liquid separator 10, which is shorter in the left-right direction than in the front-rear direction, is attached to the lower right end of the fuel cell stack 100. Therefore, except the installation space of the gas-liquid separator 10, a lot of space can be secured behind and below the fuel cell stack 100, making it easy to arrange other components around the fuel cell stack 100.

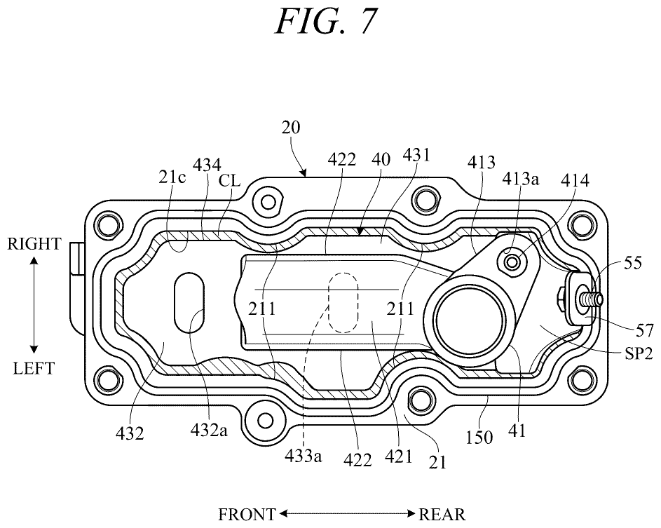

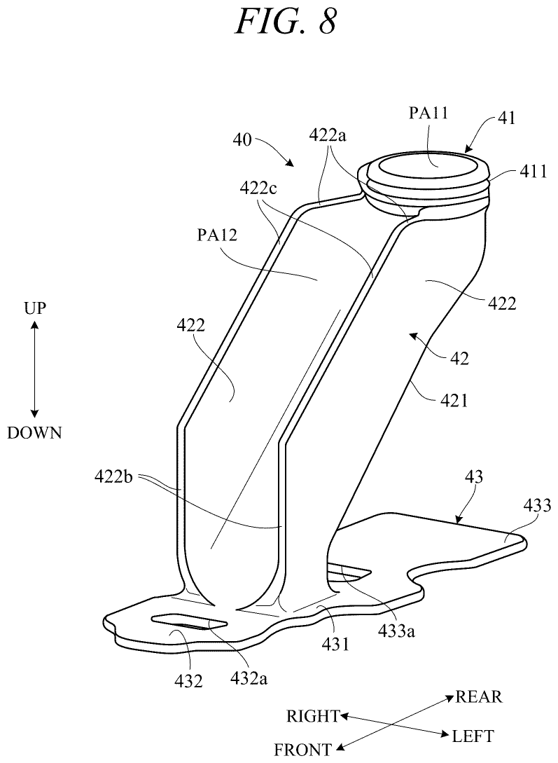

FIG. 7 is a view taken along an arrow VII in FIG. 6 (view from above). As shown in FIGS. 5 to 7, a flow path forming member 40 is arranged in the internal space SP0 of the container CA (upper container 30 is omitted in FIGS. 6 and 7). FIG. 8 is a perspective view showing an overall configuration of the flow path forming member 40. As shown in FIG. 8, the flow path forming member 40 includes a cylindrical part 41 extending in the up-down direction, an inclined part 42 extending diagonally forward and downward from the lower end of the cylindrical part 41, and a shielding part 43 extending substantially horizontally from the lower end of the inclined part 42. The cylindrical part 41, the inclined part 42, and the shielding part 43 are integrally molded with resin as the constituent material.

A groove 411 is provided on the outer peripheral surface of the cylindrical part 41 over the entire circumference. As shown in FIG. 6, a resilient sealing member 412, such as an O-ring, is fitted into the groove 411. Furthermore, on the outer peripheral surface of the cylindrical part 41, below the groove 411, a plate-shaped bracket 413 extending in a substantially horizontal direction is projected towards the right and rear. As shown in FIGS. 6 and 7, a through-hole 413a is provided at the tip portion of the bracket 413, and a bolt 414 is inserted into the through-hole 413a from below.

The bolt 414 is screwed into an unillustrated bottomed screw hole provided on the lower surface of the upper wall 33 (rear upper wall 333) of the upper container 30. Thus, the flow path forming member 40 is attached to the upper container 30 and is supported in a suspended state from the upper container 30. Therefore, the bracket 413 functions as a fixed portion for fixing the flow path forming member 40 to the upper container 30. At this time, as shown in FIG. 5, the upper end of the cylindrical part 41 fits into the lower end of the pipe part 34 through the sealing member 412. Therefore, the inside of the pipe part 34 and the inside of the cylindrical part 41 are connected airtight, and the cylindrical part 41 forms a vertical flow path PA11 that communicates with the internal path of the pipe part 34.

As shown in FIG. 8, the inclined part 42 has a substantially plate-shaped bottom wall 421 that extends downward from the rear end of the cylindrical part 41 for a predetermined length and then extends forward and downward, and a pair of left and right substantially plate-shaped side walls 422 that extend forward and upward from both ends of the bottom wall 421. The intersection between the bottom wall 421 and the side walls 422 is formed in a substantially arc shape, and the inclined part 42 is formed in a substantially U-shape in cross-section. The inclination angle of the bottom wall 421 relative to the horizontal line is set to a predetermined angle. The predetermined angle is preferably between 30° and 60°, for example, the predetermined angle is 45°. The rear end (upper end) of the side wall 422 is connected to the lower end of the cylindrical part 41, and an inclined flow path PA12, which is enclosed by the bottom wall 421 and the side walls 422 and is open upward and forward, is formed in front of the cylindrical part 41.

The upper end surface 422a of the side wall 422 in front of the cylindrical part 41 extends substantially parallel to the upper wall 33 (rear upper wall 333 in FIG. 5), that is, substantially horizontally in the front-rear direction. The front end surface 422b of the side wall 422 extends vertically so as to be substantially parallel to the front wall 221 of the lower container 20 (FIG. 5). The upper end surface 422c of the side wall 422 between the upper end surface 422a and the front end surface 422b extends inclined forward and downward substantially parallel to the bottom wall 421, and the length (height of the side wall 422) from the upper end surface 422c to the bottom wall 421 is almost constant over the entire front-rear length of the side wall 422.

As shown in FIG. 5, the upper end surface 422c is substantially parallel to the inclined upper wall 332. A circular opening at the upper end of the cylindrical part 41 functions as an inlet (a flow path inlet) PAin of the vertical flow path PA11. A substantially rectangular opening inside the front end surface 422b of the left and right side walls 422 functions as an outlet (a flow path outlet) PAout of the inclined flow path PA12. The area of the flow path outlet PAout is larger than the area of the flow path inlet PAin.

As shown in FIG. 8, the shielding part 43 is formed in a substantially plate-shape as a whole. The shielding part 43 has a mounting part 431 that is joined to the lower end of the inclined part 42, a front shielding part 432 that extends substantially horizontally forward from the mounting part 431, and a rear shielding part 433 that extends substantially horizontally rearward from the mounting part 431. As shown in FIGS. 7 and 8, a through-hole 432a elongated in the left-right direction is provided at the center portion in the front-rear direction and the center portion in the left-right direction of the front shielding part 432. In the center portion in the left-right direction of the rear shielding part 433, a through-hole 433a elongated in the left-right direction is provided near the mounting part 431 and in the center portion in the front-rear direction of the shielding part 43. Above the through-hole 433a, the bottom wall 421 of the inclined part 42 is located.

As shown in FIG. 7, on the inner edge 21c of the flange portion 21 of the lower container 20, protrusions 211 protruding towards the internal space SP0 side are provided corresponding to the positions of the screw holes 21a, and the inner edge 21c is formed in an uneven shape in plan view. The peripheral edge 434 of the shielding part 43 is formed in an uneven shape corresponding to the shape of the inner edge 21c of the flange portion 21. A gap (clearance) CL with a predetermined length (indicated by hatching for convenience) is provided over the entire circumference between the peripheral edge 434 and the inner edge 21c.

As shown in FIG. 5, in the assembled state of the container CA, the shielding part 43 is positioned above the lowermost portion 23a of the bottom wall 23 by a predetermined height. Specifically, the height from the lowermost portion 23a to the shielding part 43 is more than or equal to ¼ of the height from the lowermost portion 23a to the lower surface of the upper wall 33 (front upper wall 331). Inside the container CA, a gas-liquid separation chamber SP2 is formed above the storage chamber SP1 through the shielding part 43. The storage chamber SP1 and the gas-liquid separation chamber SP2 are communicated through the through-holes 432a and 433a of the shielding part 43 and the gap CL around the shielding part 43.

A preventing plate 50 is attached to the rear wall 322 of the upper container 30. The preventing plate 50 has a support portion 51 extending in the up-down direction along the inner surface of the rear wall 322, and an inclined portion 52 extending inclined forward and downward substantially parallel to the bottom wall 421 of the flow path forming member 40 from the lower end of the support portion 51. A through-hole is provided in the support portion 51, and by screwing a bolt 55 (FIG. 7) extending rearward through the through-hole into a bottomed screw hole provided on the front surface of the rear wall 322, the preventing plate 50 is fixed to the upper container 30. The tip of the inclined portion 52 is positioned between the upper end surface of the flange portion 21 of the lower container 20 and the upper surface of the shielding part 43. For example, the tip of the inclined portion 52 is positioned at an intermediate position in the up-down direction between the upper end surface of the flange portion 21 and the upper surface of the shielding part 43.

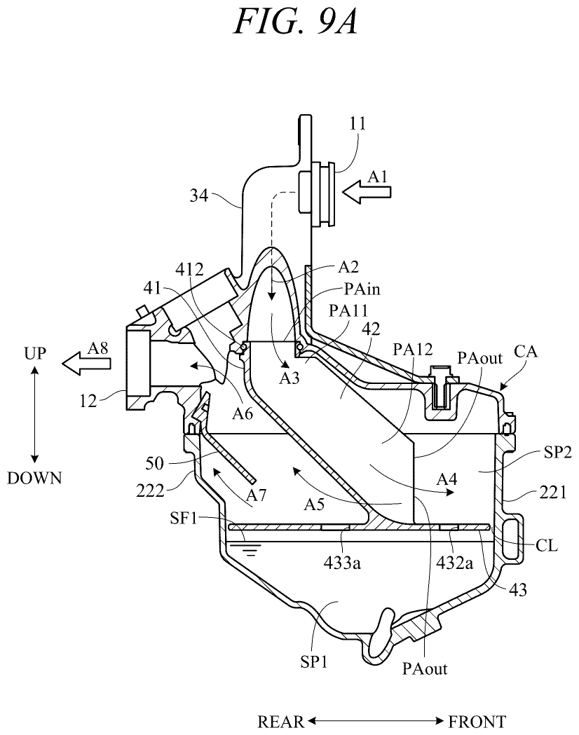

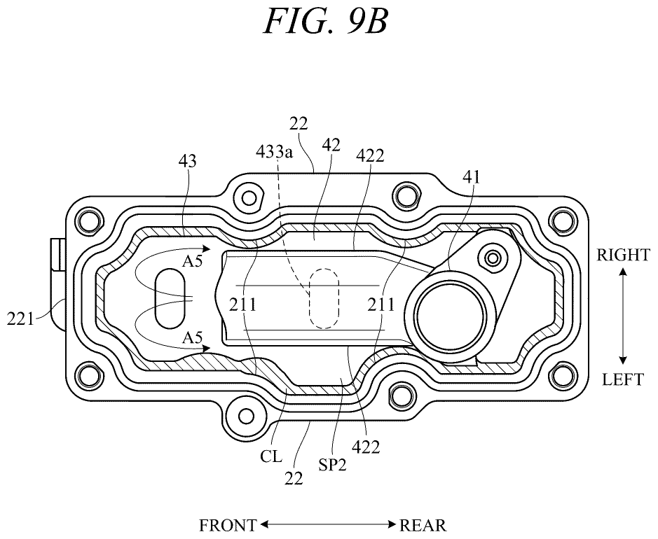

The flow of the fuel exhaust gas in the gas-liquid separator 10 configured as described above will be explained. FIG. 9A is a cross-sectional view of the gas-liquid separator 10 showing the flow of the fuel exhaust gas, and FIG. 9B is a plan view. FIGS. 9A and 9B are based on FIGS. 5 and 7, respectively. As shown by an arrow A1 in FIG. 9A, fuel exhaust gas flows into the gas-liquid separator 10 through the inlet 11. This fuel exhaust gas flows downward along the pipe part 34 (arrow A2) and flows into the vertical flow path PA11 inside the cylindrical part 41 from the flow path inlet PAin (arrow A3). Since the circumference of the cylindrical part 41 is sealed with the sealing member 412, the entire amount of the fuel exhaust gas is led to the vertical flow path PA11 without leaking from the periphery of the cylindrical part 41 to the outlet 12.

The fuel exhaust gas led to the vertical flow path PA11 flows diagonally forward and downward along the inclined flow path PA12 formed by the inclined part 42, and after its flow direction is changed to a substantially horizontal direction by the shielding part 43, the fuel exhaust gas flows out forward from the flow path outlet PAout. Thus, water, which is the liquid phase, can be separated from the fuel exhaust gas in the process where the flow direction of the fuel exhaust gas sequentially changes downward, diagonally downward, and then to the horizontal direction through the flow paths PA11 and PA12. The separated water flows downward and is stored in the storage chamber SP1 below the shielding part 43 through the through-hole 432a of the shielding part 43 or the gap CL around the shielding part 43, which is provided in the middle of the flow of the fuel exhaust gas.

As shown by an arrow A4 in FIG. 9A, the fuel exhaust gas flowing out forward from the flow path outlet PAout collides with the front wall 221 of the container CA. This separates water from the fuel exhaust gas. Since the area of the flow path outlet PAout is larger than that of the flow path inlet PAin, the flow speed of the fuel exhaust gas decreases, and the kinetic energy of the fuel exhaust gas when the fuel exhaust gas collides with the front wall 221 decreases. This allows for efficient separation of moisture from the fuel exhaust gas, and can enhance gas-liquid separation efficiency. The separated water is stored in the storage chamber SP1 through the through-hole 432a or the gap CL and becomes a stored water.

The shielding part 43 is provided above the storage chamber SP1. Therefore, it is possible to prevent the fuel exhaust gas from colliding with the water surface SF1 of the stored water, causing disturbance (turbulence) of the water surface SF1. As a result, it is possible to prevent gas-liquid separation from being hindered, such as part of the stored water being re-entrained in the fuel exhaust gas, and stable gas-liquid separation can be performed.

The fuel exhaust gas that has collided with the front wall 221 flows rearward in the gas-liquid separation chamber SP2 through the left side of the left side wall 422 and the right side of the right side wall 422 of the inclined part 42, as shown by an arrow A5 in FIG. 9B. At this time, the fuel exhaust gas collides with the protrusions 211 protruding from the left and right side walls 22 of the lower container 20. Furthermore, the fuel exhaust gas that has passed through the right side of the right side wall 422 and the fuel exhaust gas that has passed through the left side of the left side wall 422 collide behind the lower end of the inclined part 42 (mounting part 431 in FIG. 8), that is, below the inclined part 42. This causes disturbances in the flow of the fuel exhaust gas, allowing for good separation of water from the fuel exhaust gas. The separated water is stored in the storage chamber SP1 through the through-hole 433a or the gap CL below the inclined part 42.

As shown in FIG. 9A, the fuel exhaust gas that has flowed behind the inclined part 42 flows upward in the space behind the inclined part 42 towards the outlet 12 (arrow A6). In this case, the flow speed of the fuel exhaust gas is low, allowing for good separation of water from the fuel exhaust gas. The separated water is stored in the storage chamber SP1 through the through-hole 433a or the gap CL. Behind the inclined part 42, during acceleration or inclined driving of the vehicle, the fuel exhaust gas may flow (ascend) along the rear wall 222, as indicated by an arrow A7. This flow is prevented by the preventing plate 50. This prevents the moisture-containing fuel exhaust gas from reaching the outlet 12.

With the above flow of the fuel exhaust gas, the fuel exhaust gas (fuel gas) from which moisture has been sufficiently removed can be discharged from the gas-liquid separator 10 through the outlet 12 and recirculated to the ejector 204 (FIG. 2) (arrow A8).

According to the present embodiment, the following operations and effects are achievable.

(1) A gas-liquid separator 10 includes a container CA having an upper wall 33, a bottom wall 23, side walls 22 and 32 connecting the upper wall 33 and the bottom wall 23, and forming a gas-liquid separation chamber SP2 where the gas-liquid two-phase flow is separated into gas and liquid phases (FIGS. 4 and 5). The side walls 22 and 32 have front walls 221 and 321 and rear walls 222 and 322 opposed to each other (FIG. 5). In the container CA, an inlet 11 through which the gas-liquid two-phase flow flows into is provided at the tip of the pipe part 34 integrated with the upper wall 33, and an outlet 12 through which the gas phase (fuel gas) separated in the gas-liquid separation chamber SP2 flows out is provided in the rear wall 322 (FIG. 5). The gas-liquid separator 10 further includes a flow path forming member 40, particularly an inclined part 42, that forms an inclined flow path PA12 extending diagonally downward so that the fuel exhaust gas, which is a gas-liquid two-phase flow entering from the inlet 11, collides with the front wall 221 below the outlet 12 (FIG. 5).

According to this configuration, water is separated from the fuel exhaust gas by the fuel exhaust gas flowing along the inclined flow path PA12 colliding with the front wall 221. Therefore, compared to simply increasing the flow path area to reduce the flow speed, it is possible to enhance the gas-liquid separation performance. Furthermore, the gas-liquid separator 10 has a simple configuration of just placing the flow path forming member 40 inside the container CA, allowing the gas-liquid separator 10 to be compactly configured.

(2) The gas-liquid separator 10 further includes a shielding part 43 that separates the space SP0 in the container CA into a storage chamber SP1 where water separated in the gas-liquid separation chamber SP2 is stored, and a gas-liquid separation chamber SP2 above the storage chamber SP1, in a manner that the storage chamber SP1 and the gas-liquid separation chamber SP2 communicate with each other through a gap CL and through-holes 432a and 433a (FIG. 5). The shielding part 43 extends substantially horizontally below the inclined part 42 (FIG. 5). This prevents water separated from the fuel exhaust gas from being re-entrained into the fuel exhaust gas, allowing efficient gas-liquid separation.

(3) The flow path forming member 40 includes a cylindrical part 41 that extends in the up-down direction and communicates with the inlet 11, and an inclined part 42 that extends diagonally towards the front wall 221 from the lower end of the cylindrical part 41 (FIGS. 5 and 8). The cross-sectional shape of the inclined part 42 is a substantially concave shape with the upper space open (FIG. 8). Thus, by opening the upper space of the inclined part 42, the pressure of the fuel exhaust gas flowing along the inclined flow path PA12 is reduced, making it easier to separate water from the fuel exhaust gas.

(4) A gap CL is provided between the peripheral edge 434 of the shielding part 43 and the side wall 22 (FIG. 7). This allows water separated from the fuel exhaust gas to be quickly guided to the storage chamber SP1 through the gap CL.

(5) The shielding part 43 is provided with through holes 432a and 433a that penetrate the shielding part 43 (FIG. 8). This prevents water separated from the fuel exhaust gas from remaining on the shielding part 43.

(6) The shielding part 43 is fixed to the lower end of the inclined part 42 (FIG. 8). This allows the shielding part 43 to be easily supported within the container CA.

(7) The gas-liquid separator 10 further includes a preventing plate 50 that extends diagonally downward from the rear wall 322 below the outlet 12 and prevents the fuel exhaust gas from reaching the outlet 12 (FIG. 5). This prevents fuel exhaust gas containing moisture rising along the rear wall 222 during acceleration or inclined driving of the vehicle from flowing out of the outlet 12, ensuring sufficient gas-liquid separation performance.

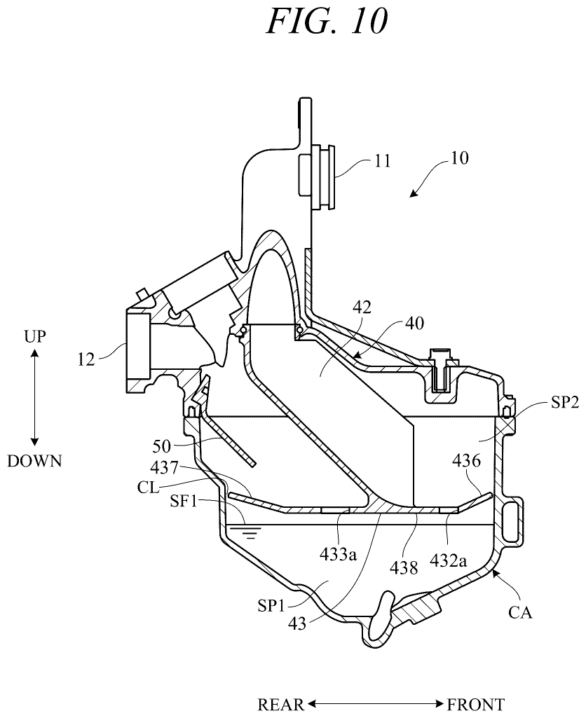

The above embodiment can be modified in various forms. Below, some modifications are described. FIG. 10 is a diagram showing a modification of FIG. 5. In FIG. 10, the configuration of the shielding part 43 of the flow path forming member 40 differs from that in FIG. 5. That is, as shown in FIG. 10, the shielding part 43 is not entirely horizontal, but the front end portion 436 and the rear end portion 437 are formed to be inclined upward from the central portion 438 in the front-rear direction. The through-holes 432a and 433a are provided in the central portion 438.

This prevents the stored water in the storage chamber SP1 from flowing to the gas-liquid separation chamber SP2 above the shielding part 43 through the gap CL and the through-holes 432a and 433a when the vehicle is inclined during such as driving on a slope. Moreover, water falling on the upper surfaces of the front end portion 436 and the rear end portion 437 is guided to the through-holes 432a and 433a of the central portion 438 along the inclined surface. This allows water separated in the gas-liquid separation chamber SP2 to be smoothly guided to the storage chamber SP1.

In the above embodiment, the container CA is configured by a lower container 20 with an open upper surface and an upper container 30 with an open lower surface. However, as long as having an upper part (upper wall), a bottom part (bottom wall), a side part (side wall), and forming a gas-liquid separation chamber where a gas-liquid two-phase flow is separated into gas phase and liquid phase, the configuration of a container can be any configuration. The separated gas phase can be something other than fuel gas, and the separated liquid phase can be something other than water. In the above embodiment, a pipe part 34 protrudes upward from the upper wall 33, and an inlet 11 is provided at the tip of the pipe part 34. However, the configuration of an upper part where the inlet is provided is not limited to this. In the above embodiment, a drainage port 13 is provided on the side of the bottom wall 23, but the configuration of a bottom part where the outlet for liquid phase is provided is not limited to this.

In the above embodiment, an outlet 12 through which the fuel gas separated in the gas-liquid separation chamber SP2 flows out is provided on the rear wall 322 (a first side part) of the container CA, and a flow path forming member 40 is provided so that the exhaust gas collides with the front wall 221 (a second side part) facing the rear wall 322 it. However, the configuration of a flow path forming part is not limited to the above configuration. That is, as long as an inclined flow path that extends diagonally downward so that the gas-liquid two-phase flowed into through the inlet collides with the second side part below the outlet is formed, the configuration of the flow path forming part can be any configuration.

In the above embodiment, the space inside the container CA, that is, the internal space SP0, is separated into a storage chamber SP1 and a gas-liquid separation chamber SP2 by a shielding part 43 (a shielding plate) provided integrally with the inclined part 42, but the configuration of the shielding plate is not limited to the above configuration. The shielding plate may be provided separately from the flow path forming part (inclined part 42) that forms the inclined flow path, and it does not necessarily have to be fixed to the lower end of the inclined part. In the above embodiment, the flow path forming member 40 has a cylindrical part 41 (a tube part) and an inclined part 42. However, as long as extending in the up-down direction and communicating with the inlet, the configuration of the tube part can be any configuration. In the above embodiment, the inclined part 42 is formed in a substantially U-shape in cross-section. However, as long as but if it is formed in a substantially concave shape in cross section, the cross-sectional shape of the inclined part can be something other than U-shape.

In the above embodiment, the storage chamber SP1 and the gas-liquid separation chamber SP2 are communicated through a gap CL provided between the peripheral edge 434 of the shielding part 43 and the side wall 22 (a side part), and the through-holes 432a and 433a provided in the shielding part 43. However, the configuration of a communication portion that allows communication between a storage chamber and a gas-liquid separation chamber is not limited to the above configuration. In the above embodiment, a preventing plate 50 is attached to the rear wall 322, but the configuration of a preventing part is not limited to the above configuration.

In the above embodiment, an example of applying the gas-liquid separator 10 to a fuel cell system mounted on a vehicle is described. However, a gas-liquid separator of the present invention can also be applied to fuel cell systems mounted on various types of industrial machines, in addition to a moving body other than a vehicle such as an aircraft or a boat, a robot, and the like. The gas-liquid separator can also be applied to a system other than a fuel cell system.

The above embodiment can be combined as desired with one or more of the above modifications. The modifications can also be combined with one another.

According to the present invention, it is possible to sufficiently enhance a gas-liquid separation performance of a gas-liquid separator.

Above, while the present invention has been described with reference to the preferred embodiments thereof, it will be understood, by those skilled in the art, that various changes and modifications may be made thereto without departing from the scope of the appended claims.

What is claimed is:

1. A gas-liquid separator comprising
a container including an upper part, a bottom part and a side part connecting the upper part and the bottom part to form a gas-liquid separation chamber where a gas-liquid two-phase flow is separated into a gas phase and a liquid phase, wherein
the side part includes a first side part and a second side part opposed to each other,
the container includes an inlet provided at the upper part so that the gas-liquid two-phase flow flows into the gas-liquid separation chamber through the inlet, and an outlet provided at the first side part so that the gas phase separated in the gas-liquid separation chamber flows out of the gas-liquid separation chamber through the outlet, and
the gas-liquid separator further comprises
a flow path forming part forming an inclined flow path extending diagonally downward so that the gas-liquid two-phase flow flowed into through the inlet collides with the second side part below the outlet.

2. The gas-liquid separator according to claim 1, further comprising
a shielding plate configured to separate a space in the container into a storage chamber where the liquid phase separated in the gas-liquid separation chamber is stored and the gas-liquid separation chamber above the storage chamber, under a state where the storage chamber and the gas-liquid separation chamber communicate with each other through a communication portion, and
the shielding plate is provided so as to extend substantially horizontally below the flow path forming part.

3. The gas-liquid separator according to claim 2, wherein
the flow path forming part includes a tube part extending in a vertical direction to communicate with the inlet, and an inclined part extending diagonally toward the second side part to connect with a lower end portion of the tube part, and
a cross-sectional shape of the inclined part is substantially concave with an upper space open.

4. The gas-liquid separator according to claim 2, wherein
the communication portion is configured by a gap between a peripheral portion of the shielding plate and the side part.

5. The gas-liquid separator according to claim 2, wherein
the communication portion is configured by a through hole penetrating the shielding plate.

6. The gas-liquid separator according to claim 2, wherein
the shielding plate is fixed to a lower end portion of the flow path forming part.

7. The gas-liquid separator according to claim 1, further comprising
a preventing part extending diagonally downward from the first side part below the outlet toward the second side part to prevent the gas-liquid two-phase flow from flowing toward the outlet.

8. The gas-liquid separator according to claim 1, wherein
the container includes a lower container having an open upper surface and an upper container having an open lower surface attached to an upper end surface of the lower container,
each of the lower container and the upper container includes the first side part and the second side part,
the outlet is provided at the first side part of the upper container, and
the flow path forming part forms the inclined flow path so that the gas-liquid two-phase flow flowed into through the inlet collides with the second side part of the lower container.

9. The gas-liquid separator according to claim 8, wherein
the flow path forming part includes a fixed portion fixed to the upper container.

10. The gas-liquid separator according to claim 1, wherein
the inclined flow path includes a flow path inlet and a flow path outlet respectively provided an upper end portion and a lower end portion of the inclined flow path, and
an opening area of the flow path inlet is smaller than an opening area of the flow path outlet.
